(19) United States
(12) Patent Application Publication
(10) Pub. No.: US 2008/0032004 A1
(43) Pub. Date: Feb. 7, 2008

(54) METHOD OF PREPARING PIZZA

(75) Inventors: Cathryn Fritz-Jung, Grosse Pointe Farms, MI (US); Deborah Auer, Dearborn, MI (US); Hiba Kakish, Dearborn, MI (US); Amanda B. Thomas, Livonia, MI (US)

Correspondence Address: HARNESS, DICKEY & PIERCE, P.L.C., P.O. BOX 828, BLOOMFIELD HILLS, MI, 48303, US

(73) Assignee: Little Caesar Enterprises, Inc., Detroit, MI (US)

(21) Appl. No.: 11/462,539

(22) Filed: Aug. 4, 2006

(51) Int. Cl. A21D 13/00

(52) U.S. Cl. 426/94

(57) ABSTRACT

A method of preparing pizza includes providing an at least partially baked crust with at least one topping. The crust and at least one topping are wrapped or covered with an impermeable cover and heated to a holding temperature above ambient temperature. The cover is then removed and additional heated and un-heated toppings may be added. The pizza is then baked in an oven to further heat and brown the crust, cheese and toppings of the pizza. With the method, the final bake time can be reduced to preferably less than 60 seconds.

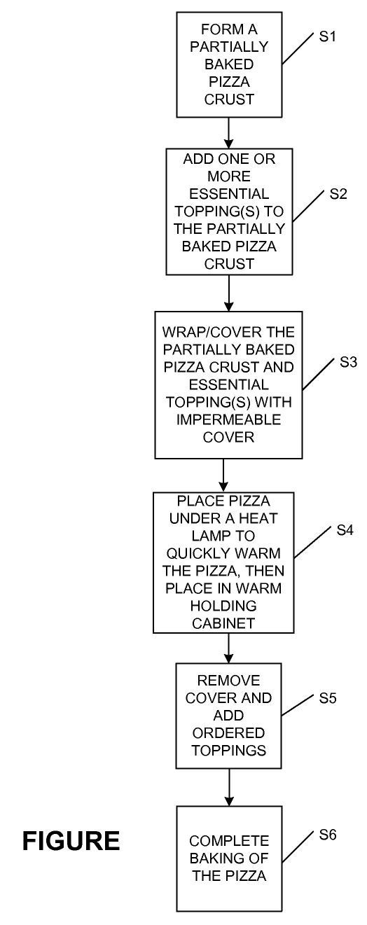

### FIELD

The present disclosure relates to a method of making pizza, and more particularly, to a method of reducing the amount of bake time required for a pizza.

### BACKGROUND AND SUMMARY

The statements in this section merely provide background information related to the present disclosure and may not constitute prior art.

Pizzeria restaurants which provide take-out and dine-in services are highly competitive with several pizzeria restaurants competing in small towns and neighborhoods. In addition, fast food restaurants have experimented with selling pizza as part of a wider expanding variety of food choices being provided. Previously, pizzeria style pizza was not typically considered to be competitive with the fast-food industry due to the amount of time required for baking a freshly made pizza. However, the success of the HOT N' READY® pizza offered by Little Caesar's® has shown to be largely successful for diners wishing to have a freshly baked pizza with minimal wait time.

In addition, pizzerias have had success in selling pizza by the slice. A problem encountered by pizzerias in selling pizzas by the slice is that if the pizzas are not sold rapidly enough, pizzas can become stale or cold and undesirable to the consumer. In addition, because of the requirement that the pizzas be prepared in advance, it is difficult for the pizzeria to prepare the pizzas in a rapid fashion with different variations of assorted toppings. The typical pizzeria that offers pizza by the slice typically limits their offerings to two, or sometimes three, varieties of pizzas. Another solution sometimes utilized is to reheat the pizza slices for a customer if a pizza has been sitting out long enough to become cold. However, re-heating a fully cooked pizza slice can alter the taste, texture, and overall desirability of the pizza to the consumer.

U.S. Pat. No. 4,367,243 entitled “Method for Preparing Cooking Pizza” discloses a method for preparing a pizza in which the shell or crust is partially pre-baked and is stored by either cooling or freezing the pre-baked crust for future use. The partially pre-baked crusts are then used with a heated pizza sauce and other toppings are applied prior to a final baking process which is disclosed as requiring approximately 3.5 minutes. However, it is still desirable to provide a method of more rapidly preparing a pizza.

Accordingly, the present disclosure provides a method of preparing a pizza comprising partially baking a pizza shell, applying toppings such as sauce and cheese to the partially baked pizza shell, sealingly covering the pizza shell with toppings and heating the covered pizza shell and toppings to a holding temperature and adding additional toppings and finally baking said pizza to a second temperature that is greater than the holding temperature. The added toppings can also be heated to a second predetermined holding temperature prior to being placed on the pizza shell and toppings that were heated to the holding temperature. The final baking time of a large pizza is greatly reduced to less than 3 minutes (more preferably, less than 1 minute) and allows the preparation of a special order pizza. The bake time will vary depending upon the size and thickness of the pizza.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

The FIGURE is a flow diagram illustrating the method steps for preparing a pizza according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to the FIGURE, a flow diagram illustrating the method steps for making a pizza, according to the present disclosure, will now be described. First, at Step S1, an at least partially baked pizza crust is formed. It is preferred that the pizza crust is baked approximately 60-100% although other amounts of partially baking can be utilized. The amount the crust is baked can depend upon the size (diameter) and thickness of the crust. The amount of gelatinization of the starch contained in the crust can be between 60-100% with the crust not being browned or being only partially browned. The at least partially baked crust can be pre-made and stored either at ambient temperature or can be refrigerated or frozen.

At Step S2, one or more “essential” toppings are added to the partially baked pizza crust. The “essential” toppings can include but are not intended to be limited to a sauce and/or a cheese. The “essential” toppings are intended to include the toppings that are typically included on each pizza order. For different pizza's the essential toppings may vary. The essential toppings can be pre-heated, at ambient temperature, or otherwise refrigerated when added to the partially baked pizza crust.

At step S3, the partially baked pizza crust and essential toppings are wrapped or otherwise covered with an impermeable material. The impermeable wrap or cover can include a plastic wrap, a foil, or other plastic or metal cover. The use of a wrap or cover is intended to maintain the moisture content of the partially baked crust and the essential toppings. The wrap or cover can be a re-usable cover that can resealably engage the pan. Without intending to be limited by theory, the wrap or cover should preferably closely engage the assembled pizza.

At Step S4, the covered assembled pizza may be quickly warmed to 120-170° F. under a heat lamp for approximately ten minutes, and is then kept in a warm holding cabinet having a temperature of between 100 and 180° F. and more preferably, approximately 140-150° F. The holding cabinet preferably heats the partially baked crust and essential toppings to a predetermined temperature with the wrap or covering maintaining the moisture content of the ingredients.

When a pizza is ordered, the assembled pizza is removed from the holding cabinet, the cover or wrap is removed and the “ordered” toppings are added to the pizza assembly at step S5. The “ordered” toppings can include any toppings requested by a customer. Without intending to be limiting, the “ordered” toppings can include cheese, sauce, pepperoni, ham, sausage, ground beef, peppers, onions, anchovies, mushrooms, pineapple or other known toppings. Some of the “ordered toppings can be pre-heated to a holding temperature which can be the same as or different from the holding temperature of the holding cabinet. For example, meat toppings may be pre-heated to a holding temperature so that they can be immediately applied to the assembled pizza prior to final baking. With regard to pineapple and some vegetable toppings, it may not be desirable to pre-heat the toppings.

At step S6, the fully assembled pizza is then inserted into an oven to complete the baking of the pizza, as ordered. It should be noted that the oven can be an infrared electric radiant heat-type oven (commercially available under the name QMATIC), a toaster-type oven, a convection-type oven, or any other type of conventional oven used in pizzerias The final baking step is intended to further heat the pizza and brown or further brown the crust, cheese and toppings of the pizza. Because the crust, sauce, cheese and pre-heated “ordered” toppings are all pre-heated to the respective holding temperatures, the final baking time can be reduced to less than three minutes and preferably less than two minutes and more preferably, between 5 and 60 seconds depending upon the size and thickness of the crust and depending upon the amount of toppings. In particular, for a small thin crust pizza, the final bake time can be as little as 5 seconds.

With the method of the present disclosure, a made-to-order pizza can be assembled and baked in minimal time without compromising quality, freshness, or taste.

What is claimed is:

1. A method comprising:
preparing an at least partially baked pizza crust;
adding at least one topping to said pizza crust;
covering said pizza crust and said at least one topping with an impermeable cover;
heating said covered pizza crust and said at least one topping at a holding temperature above ambient temperature;
removing said impermeable cover; and
baking the partially baked pizza crust and at least one topping in an oven to complete baking of the pizza.

2. The method according to claim 1, wherein said step of baking includes baking for less than three minutes.

3. The method according to claim 1, wherein said step of baking includes baking for less than two minutes.

4. The method according to claim 1, wherein said step of baking includes baking for less than one minute.

5. The method according to claim 1, wherein said impermeable cover includes one of a plastic wrap, a foil, a plastic cover and a metal cover.

6. The method according to claim 1, wherein said holding temperature is between 100 and 180° F.

7. The method according to claim 1, wherein said holding temperature is between 140 and 150° F.

8. The method according to claim 1, wherein said step of heating said covered pizza crust and said at least one topping to a holding temperature includes placing the pizza crust under a heating lamp for a predetermined period of time.

9. The method according to claim 8, wherein said step of heating said covered pizza crust and said at least one topping to a holding temperature includes placing said pizza crust in a heated holding cabinet after being placed under the heating lamp.

10. The method according to claim 1, wherein said step of heating said covered pizza crust and said at least one topping to a holding temperature includes placing said pizza crust in a heated holding cabinet.

11. The method according to claim 1, wherein after said step of removing said impermeable cover, at least one additional topping is added to said at least partially baked crust.

12. The method according to claim 11, wherein said at least one additional topping is pre-heated above ambient temperature.

13. The method according to claim 1, wherein said at least partially baked pizza crust is partially baked so as to have at least 60% gelatinization of the starch in the crust.

14. The method according to claim 1, wherein the step of baking the pizza crust and at least one topping in an oven includes baking in an infrared electric radiant heat-type oven.

15. A method comprising:
preparing a pizza crust;
adding at least one topping to said pizza crust;
covering said pizza crust and said at least one topping with an impermeable cover;
heating said covered pizza crust and said at least one topping at a holding temperature above ambient temperature;
removing said impermeable cover; and
baking the pizza crust and at least one topping in an oven to complete baking of the pizza.

16. The method according to claim 15, wherein said step of baking includes baking for less than three minutes.

17. The method according to claim 15, wherein said step of baking includes baking for less than two minutes.

18. The method according to claim 15, wherein said step of baking includes baking for less than one minute.

19. The method according to claim 15, wherein said holding temperature is between 100 and 180° F.

20. The method according to claim 15, wherein said step of heating said covered pizza crust and said at least one topping to a holding temperature includes placing the pizza crust under a heating lamp for a predetermined period of time.

21. The method according to claim 15, wherein said step of heating said covered pizza crust and said at least one topping to a holding temperature includes placing said pizza crust in a heated holding cabinet.

22. The method according to claim 15, wherein after said step of removing said impermeable cover, at least one additional topping is added to said at least partially baked crust.

23. The method according to claim 22, wherein said at least one additional topping is pre-heated above ambient temperature.

24. The method according to claim 15, wherein the step of baking the pizza crust and at least one topping in an oven includes baking in an infrared electric radiant heat-type oven.

25. A method comprising:
preparing an at least partially baked pizza crust;
adding at least one topping to said pizza crust;
covering said pizza crust and said at least one topping with an impermeable cover;
heating said covered pizza crust and said at least one topping at a holding temperature above ambient temperature;
removing said impermeable cover;
adding at least one additional topping to said pizza crust; and
baking the pizza crust and at least one topping in an oven to complete baking of the pizza.

26. The method according to claim 25, wherein said at least one additional topping is pre-heated above ambient temperature.

27. The method according to claim 25, wherein said holding temperature is between 100 and 180° F.

28. The method according to claim 25, wherein said step of baking includes baking for less than one minute.

29. The method according to claim 25, wherein said step of heating said covered pizza crust and said at least one topping to a holding temperature includes placing the pizza crust under a heating lamp for a predetermined period of time.

30. The method according to claim 25, wherein the step of baking the pizza crust and at least one topping in an oven includes baking in an infrared electric radiant heat-type oven.

31. A method comprising:
preparing an at least partially baked pizza crust;
adding at least one topping to said pizza crust;
covering said pizza crust and said at least one topping with a cover;
heating said covered pizza crust and said at least one topping at a holding temperature above ambient temperature;
removing said cover; and
baking the pizza crust and at least one topping in an oven to complete baking of the pizza.

32. The method according to claim 31, wherein said holding temperature is between 100 and 180° F.

33. The method according to claim 31, wherein said step of baking includes baking for less than one minute.

34. The method according to claim 31, wherein said step of heating said covered pizza crust and said at least one topping to a holding temperature includes placing the pizza crust under a heating lamp for a predetermined period of time.

35. The method according to claim 31, wherein the step of baking the pizza crust and at least one topping in an oven includes baking in an infrared electric radiant heat-type oven.

36. A method comprising:
preparing an at least partially baked pizza crust;
adding at least one topping to said pizza crust;
heating said pizza crust and said at least one topping at a holding temperature above ambient temperature;
adding at least one additional topping to said pizza crust; and
baking the pizza crust and at least one additional topping in an oven to complete baking of the pizza.

37. The method according to claim 36, wherein said holding temperature is between 100 and 180° F.

38. The method according to claim 36, wherein said at least one additional topping is pre-heated above ambient temperature.

39. The method according to claim 36, wherein said step of baking includes baking for less than one minute.

40. The method according to claim 36, wherein said step of heating said covered pizza crust and said at least one topping to a holding temperature includes placing the pizza crust under a heating lamp for a predetermined period of time.

41. The method according to claim 36, wherein the step of baking the pizza crust and at least one topping in an oven includes baking in an infrared electric radiant heat-type oven.
